(19) United States
(12) Patent Application Publication
(10) Pub. No.: US 2002/0080117 A1
(43) Pub. Date: Jun. 27, 2002

(54) Optical mouse

(75) Inventors: Sang Eun Son, Kyungki-Do (KR); Young Gi Kim, Kyungki-Do (KR)

Correspondence Address: LADAS & PARRY, 26 WEST 61ST STREET, NEW YORK, NY, 10023, US

(73) Assignee: SAMSUNG ELECTRO-MECHANICS CO., LTD

(21) Appl. No.: 09/850,575

(22) Filed: May 7, 2001

(30) Foreign Application Priority Data
Dec. 21, 2000 (KR) P2000-79901

(51) Int. Cl. G09G 5/08

(52) U.S. Cl. 345/163

(57) ABSTRACT

Disclosed is an optical mouse which can move a cursor on a display screen of a computer system by varying arrangement of optical parts and structures using regularly reflected light in light emitted from a light source so as to allow the regularly reflected light to enter into a sensor. The optical mouse includes a light source for emitting light, an irradiating lens for condensing the light emitted from the light source and downwardly irradiating the light at a predetermined angle, a light-receiving lens for condensing light regularly reflected upon a reflecting surface on a path where light emitted from the light source and irradiated through the irradiating lens is reflected, and an optical sensor for sensing the light condensed through the light-receiving lens.

### BACKGROUND OF THE INVENTION

1. Field of the Invention

The present invention relates to an optical mouse, and more particularly to, an optical mouse which can move a cursor on a display screen of a computer system by varying arrangement of optical parts and structures using regularly reflected light in light emitted from a light source so as to allow the regularly reflected light to enter into a sensor.

2. Description of the Prior Art

Generally, in a mouse used as a main input means of a computer, a mechanically moving portion, for example, a ball mouse having a ball has problems in that sliding occurs due to dust and a user's movement may not be exactly transferred to a display screen of a computer system when the user moves the ball mouse. Also, a problem arises in that it is difficult to use the ball mouse for a long time due to abrasion of the ball and parts in contact with the ball.

To solve such problems, there has been suggested an optical mouse. The optical mouse includes a sensor array consisting of a plurality of optical sensors, optical parts for condensing light reflected upon the optical sensors, and mechanical structures.

FIG. 1 shows a relationship between a surface and a sensor array. Referring to FIG. 1, light emitted from a light source such as a light-emitting diode (LED) is reflected upon the surface, and cells of optical sensors of the sensor array sense the reflected light.

FIG. 2 shows tracking by comparison of bitmaps. Referring to FIG. 2, a sensor array consisting of a plurality of optical sensors compares bitmaps generated by sensing light, so that movement and direction of devices are provided by movement of a cursor of a computer system.

At this time, the generated bitmaps are constituted by a binary form (1 or 0).

FIG. 3 shows a configuration of a related art optical mouse.

Referring to FIG. 3, a reference numeral 11 denotes a button pressed by a user, a reference numeral 12 denotes a switch turned on/off depending on the operation of the button 11, and a reference numeral 13 denotes a circuit board that supports the switch 12.

Also, a reference numeral 14 denotes a light source that emits light, a reference numeral 15 denotes a lens for condensing light, and a reference numeral 16 denotes a housing that supports the overall structure. A reference numeral 17 denotes a lens integrated circuit (IC) that includes a sensor array, a logic circuit, and an inverter. A reference numeral 18 denotes a surface and a reference numeral 19 denotes an optical guide that guides light from the surface 18 to the lens IC 17.

The operation of the aforementioned optical mouse will briefly be described with reference to FIGS. 3 and 4. Light emitted from the light source 14 and reflected upon the surface 18 is condensed by the lens 15 and transferred to cells of the optical sensor of the lens IC 17, so that the optical sensor array converts moving optical images sensed by light to circuit signals. Thus, the converted circuit signals are transferred to a computer system to be displayed on a display screen by moving a cursor.

That is, since most of the emitted light is reflected upon a general surface, sufficient light to be sensed by the sensor is obtained. Accordingly, no problem arises in that the optical mouse is operated.

However, the optical mouse, as shown in FIG. 5, has a surface far away from a glass by a thickness of the glass in transferring the light to the sensor. In this case, light of 90% or greater is transmitted on the glass to cause the amount of the reflected light to be lack, thereby resulting in that the sensor fails to sense the light. For this reason, a problem arises in that the sensor does not function as a control device.

In other words, the aforementioned optical mouse is based on light irregularly reflected upon the surface. As shown in FIG. 5, light which has not passed through a transparent medium such as a glass is absolutely lack of the amount of irregularly reflected light. After all, the aforementioned related art optical mouse has several problems. The optical sensor fails to sense images on the glass so as not to move a cursor of a display screen of the computer system. This is because that the light-receiving lens and the sensor are set at a particular point in an irregularly reflected light path on the surface under the circumstances that there is no transparent medium, at the time of design of the optical mouse, so as not to allow the reflected light which has transmitted the transparent medium to advance to the light-receiving lens and the sensor.

### SUMMARY OF THE INVENTION

It is, therefore, an object of the present invention to provide an optical mouse which can move a cursor on a display screen of a computer system by varying arrangement of optical parts and structures using regularly reflected light in light emitted from a light source so as to allow the regularly reflected light to enter into a sensor.

To achieve the above object, there is provided an optical mouse which includes a light source for emitting light, an irradiating lens for condensing the light emitted from the light source and downwardly irradiating the light at a predetermined angle, a light-receiving lens for condensing light regularly reflected upon a reflecting surface on a path where light emitted from the light source and irradiated through the irradiating lens is reflected, and an optical sensor for sensing the light condensed through the light-receiving lens.

The optical mouse according to the present invention is characterized in that the reflecting surface is a general surface or an upper surface of a transparent medium.

The optical mouse according to the present invention is also characterized in that the light-receiving lens's central shaft is located on a light path for a regular reflection angle corresponding to an incident angle of irradiating light entered upon the surface if the light emitted from the light source is downwardly irradiated by the irradiating lens, and the irradiating lens and the light-receiving lens are formed in an integral form with each other.

### BRIEF DESCRIPTION OF THE DRAWINGS

The above objects, features and advantages of the present invention will become more apparent from the following detailed description when taken in conjunction with the accompanying drawings, in which:

FIG. 1 shows a relationship between a surface and a sensor array;

FIG. 2 shows tracking by comparison of bitmaps;

FIG. 3 shows a configuration of a related art optical mouse;

FIG. 4 shows the operation on a general surface of the related art optical mouse;

FIG. 5 shows the operation on a glass of the related art optical mouse;

FIG. 6 is an exemplary view illustrating regular reflection according to the present invention;

FIG. 7 shows a configuration of an optical mouse according to the present invention; and

FIG. 8 shows the operation on a glass of the optical mouse according to the present invention.

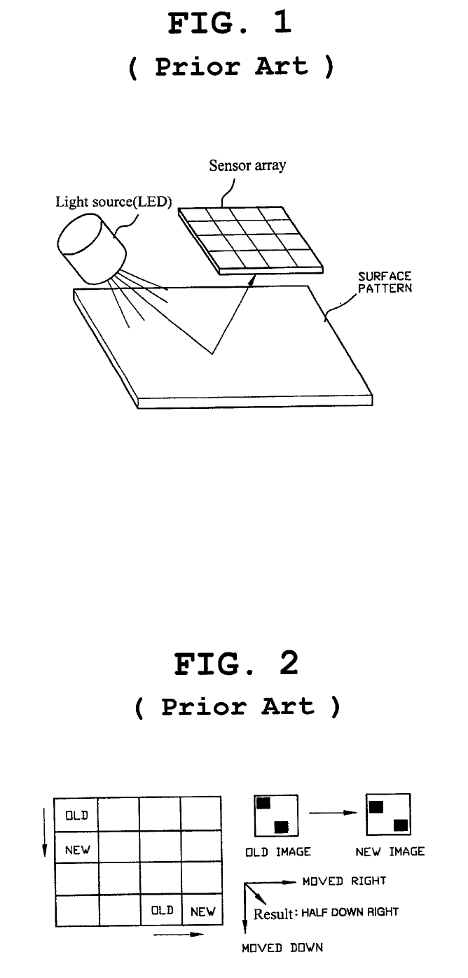

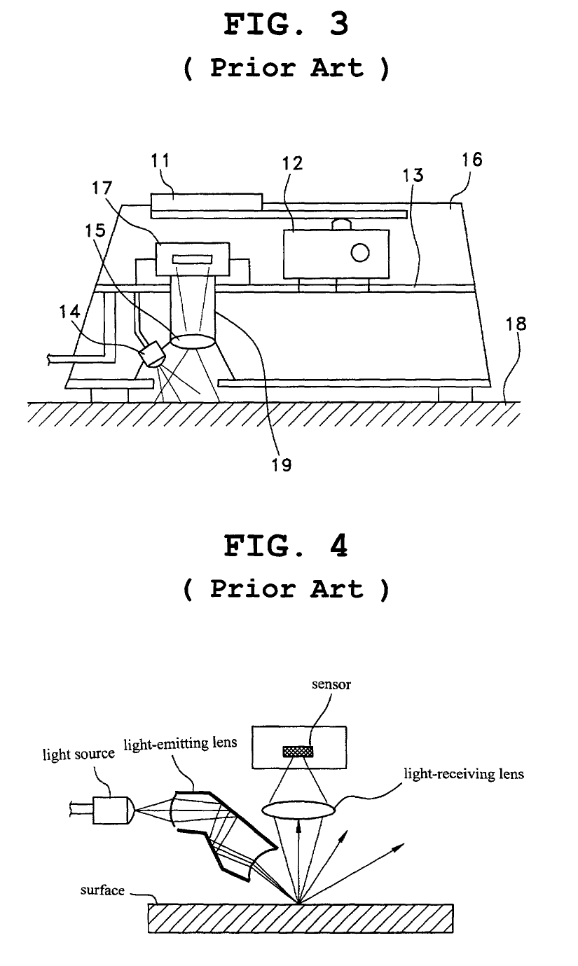

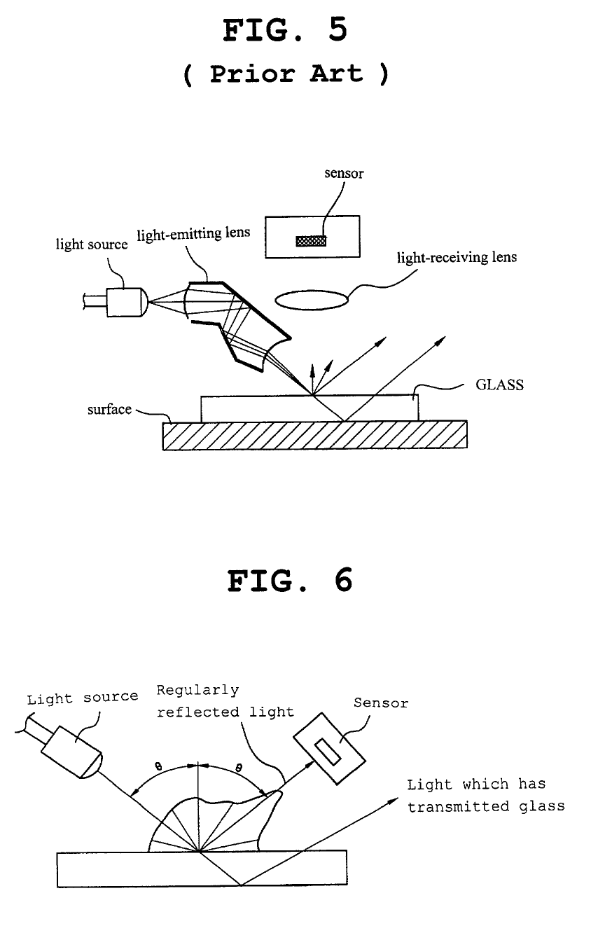

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

First, regular reflection of the present invention will be described with reference to FIG. 6.

90% of light emitted from a light source transmits a glass but the other light is reflected upon the glass. At this time, 4% of the light reflected upon the glass is regularly reflected (incident angle=reflecting angle) while the other light is dispersed.

In this respect, it is intended in the present invention that a cursor can move on a display screen of a computer system by varying arrangement of optical parts and structures to allow the regularly reflected light to enter into a light-receiving sensor.

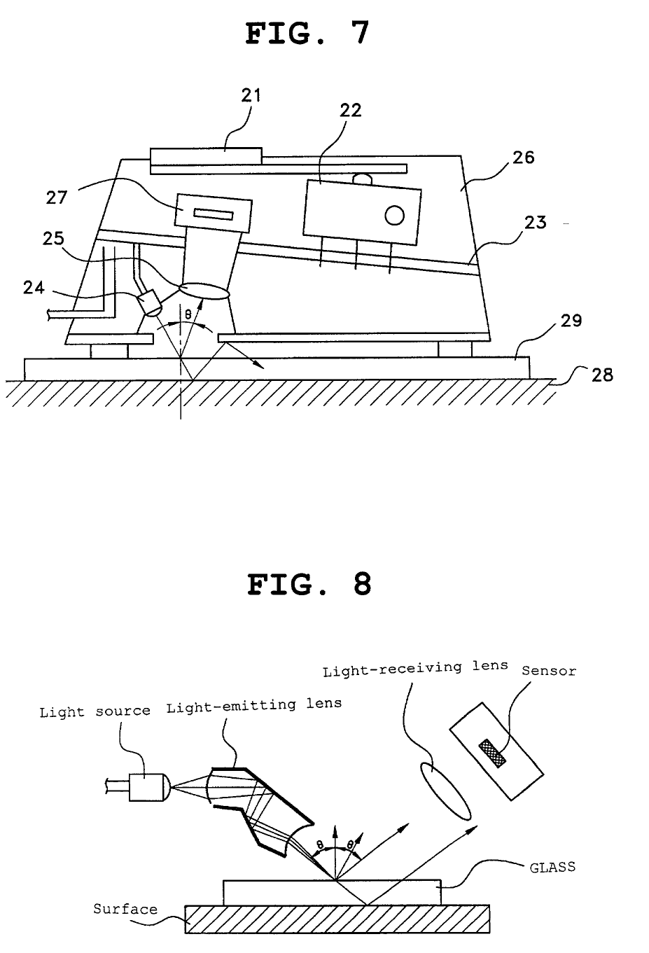

A configuration of an optical mouse according to the present invention based on the regularly reflected light is shown in FIG. 7.

Referring to FIG. 7, a reference numeral 21 denotes a button pressed by a user, a reference numeral 22 denotes a switch turned on/off depending on the operation of the button 21, and a reference numeral 23 denotes a circuit board that supports the switch 22.

Also, a reference numeral 24 denotes a light source that emits light, a reference numeral 25 denotes a light-receiving lens for condensing light, and a reference numeral 26 denotes a housing that supports the overall structure. A reference numeral 27 denotes a lens integrated circuit (IC) that includes a sensor array, a logic circuit, and an inverter. A reference numeral 28 denotes a surface and a reference numeral 29 denotes a glass.

In the aforementioned optical mouse according to the present invention, the light-receiving lens 25 is located on a reflecting angle θ of the regularly reflected light to allow the light-receiving sensor to sense the light regularly reflected upon the glass, and the circuit board 23 is inclined by the reflecting angle θ to be assembled into the housing 26.

The operation of the optical mouse on the glass will now be described with reference to FIG. 8.

When the optical mouse is on the glass, the light emitted from the light source transmits the glass and is reflected upon the surface. The regularly reflected light in the light reflected upon the surface is condensed through the light-receiving lens located with a central shaft on a regular reflection path. The light passed through the light-receiving lens is condensed on the optical sensor to allow the optical sensor to sense the light. Thus, the optical mouse can be operated on the glass as well as the surface, so that the cursor can move on the display screen of the computer system.

At this time, a light-emitting lens and the light-receiving lens may be formed in an integral form with each other.

Referring to FIG. 8, the light source and the light-emitting lens are denoted by one reference numeral 24 of FIG. 7.

As aforementioned, the optical mouse according to the present invention has the following advantage.

The configuration of the optical sensor and the lens is varied to receive the light emitted from the light source and regularly reflected upon the glass. Thus, it is possible to move the cursor on the display screen of the computer system by allowing the optical sensor to sense the light on the transparent material such as a glass using the regularly reflected light in the light emitted from the light source.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical mouse comprising:
a light source for emitting light;
a light-receiving lens for condensing light regularly reflected from a reflecting surface on a path where light emitted from the light source and irradiated through the irradiating lens is reflected; and
an optical sensor for sensing the light condensed through the light-receiving lens.

2. The optical mouse of claim 1, further comprising an irradiating lens for condensing the light emitted from the light source and downwardly irradiating the light at a predetermined angle.

3. The optical mouse of claim 1, wherein the reflecting surface is a general surface or an upper surface of a transparent medium.

4. The optical mouse of claim 1, wherein the light-receiving lens's central shaft is located on a light path of a regular reflection angle corresponding to an incident angle of irradiating light entered upon the surface if the light emitted from the light source is downwardly irradiated by the irradiating lens.

5. The optical lens of claim 2, wherein the irradiating lens and the light-receiving lens are formed in an integral form with each other.
